(19) United States
(12) Patent Application Publication
(10) Pub. No.: US 2017/0032876 A1
(43) Pub. Date: Feb. 2, 2017

(54) SmCo-BASED RARE EARTH SINTERED MAGNET

(71) Applicant: NAMIKI SEIMITSU HOUSEKI KABUSHIKI KAISHA, Tokyo (JP)

(72) Inventors: Motoichi NAKAMURA, Kuroishi-shi (JP); Shingo SUZUKI, Kuroishi-shi (JP); Kazuya NAKAMURA, Kuroishi-shi (JP); Akira SATO, Kuroishi-shi (JP); Kouji OKI, Kuroishi-shi (JP); Kinya ODAGIRI, Kuroishi-shi (JP); Takeshi KOGAWA, Kuroishi-shi (JP); Tomoyuki KUGO, Tokyo (JP); Ayumu SUTO, Kuroishi-shi (JP)

(73) Assignee: NAMIKI SEIMITSU HOUSEKI KABUSHIKI KAISHA, Tokyo (JP)

(21) Appl. No.: 15/303,600

(22) PCT Filed: Apr. 14, 2015
(86) PCT No.: PCT/JP2015/061468

§ 371 Date: Oct. 12, 2016

(30) Foreign Application Priority Data
Apr. 16, 2014 (JP) 2014-084525

(51) Int. Cl. H01F 1/059; H01F 1/055; B22F 3/10; B22F 5/10; C22C 19/07; C22C 19/00

(52) U.S. Cl. CPC H01F 1/059; C22C 19/07; C22C 19/007; B22F 3/10; B22F 5/106; H01F 1/0557; B22F 2302/45

(57) ABSTRACT

To provide an SmCo-based rare earth sintered magnet having a small diameter and a multipolar magnetized magnetic structure and having a high coercive force and a high magnetization rate. The outer shape of an SmCo-based rare earth sintered magnet having a coercive force HCJ (kOe) at a room temperature (° C.) of 7.5 (kOe)<HCJ≦27 (kOe) is formed into any one of a cylindrical shape, a ring-like shape, a columnar shape, and a disk-like shape. Multi-pole magnetization is performed on the SmCo-based rare earth sintered magnet so as to satisfy (diameter D/the number of poles p) (mm)<(4/π) (mm) (p is an even number equal to or greater than 4), and the magnetization rate is set to 80(%) or more.

### TECHNICAL FIELD

The present invention relates to an SmCo-based rare earth sintered magnet.

### BACKGROUND ART

Heretofore, Alnico magnets have been used mainly for permanent magnet motors for precision equipment with a high resistance to heat. However, in recent years, along with the market trend toward a reduction in size and weight of precision equipment, an SmCo-based rare earth magnet has been used in place of an Alnico magnet as a magnet to be mounted on a permanent magnet motor for precision equipment. The SmCo-based rare earth magnet has the following features and various developments have been made as an extremely excellent magnetic material.

First, the SmCo-based rare earth magnet has a maximum energy product (BH)max(J/m3) that is second largest only to that of an NdFeB-based rare earth magnet among the magnets in practical use, and the volume of the magnet to be amounted on a motor or the like can be reduced, which leads to a reduction in size and weight of equipment. A residual magnetic flux density Br (T) of the SmCo-based rare earth magnet is about the same as that of an Alnico magnet. Further, a coercive force (Oe) of the SmCo-based rare earth magnet is extremely large, that is, about 10 times that of the Alnico magnet. Accordingly, unlike the Alnico magnet, there is no need to design the SmCo-based rare earth magnet with a large dimension in a magnetization direction, which greatly contributes to miniaturization in the design of the high precision equipment with a high resistance to heat.

Further, a demagnetization curve is substantially straight and recoil magnetic permeability close to 1 and excellent thermal stability are obtained, and thus the SmCo-based rare earth magnet is advantageous in practical use.

While the SmCo-based rare earth magnet has the above-mentioned advantages, the recent market trend of permanent magnet motors is leaning toward a reduction in weight and an increase in output. Accordingly, the magnet to be mounted on a motor is required to be multipolarized, as well as to be miniaturized and highly resistant to heat.

As a method for performing multipolar magnetization on a rare earth sintered magnet to be incorporated in a permanent magnet motor, a magnetization device of a coil energizing scheme is used. A hole through which a rare earth sintered magnet, which is an object to be magnetized, can be inserted and removed is formed at the center of a magnetic yoke, and grooves extending axially are formed in the inner wall surface of the hole according to the number of poles of magnetization. Further, insulation-coated conductors are buried in the grooves and adjacent conductors form a coil in a continuous zigzag shape.

The object to be magnetized is inserted into the hole and an electric charge stored in a capacitor is discharged in an instant to cause a pulse current to flow through a coil, and the rare earth sintered magnet is magnetized by a magnetized magnetic field generated in the magnetic yoke due to the pulse current.

However, as the market trend of permanent magnet motors is leaning toward a reduction in size and weight, the rare earth sintered magnet to be mounted on a permanent magnet motor is also required to be miniaturized. Accordingly, as the magnetization pitch (magnetization pole distance) is narrowed, the magnetic yoke is required to be reduced accordingly. For this reason, a space which can be used for winding is reduced in accordance with the miniaturization of the magnetic yoke, so that the diameter of the conductor of the coil to be placed is unavoidably reduced. Further, it is difficult to wind the conductor with a sufficient number of turns, so that the strength of the magnetized magnetic field which can be generated by the magnetic yoke is limited. Thus, there arises a problem that the magnetization cannot be sufficiently performed.

In particular, the initial magnetization of the SmCo-based rare earth magnet shows characteristics of pinning-type coercive force. Accordingly, when the magnetized magnetic field required for saturated magnetization increases and a sufficient magnetized magnetic field is not applied, the magnetization rate becomes insufficient.

In the rare earth sintered magnet whose magnetization rate is insufficient, an irreversible flux loss due to a temperature rise occurs at a temperature lower than that of the rare earth sintered magnet subjected to saturated magnetization. In particular, a rare earth sintered magnet to be incorporated in a small motor having a size of 20 (mm) or less is preferably subjected to saturated magnetization so that an irreversible flux loss due to the generation of heat in a coil can be prevented, that is, so that the use upper-limit temperature of the motor can be increased.

A method for heating an object to be magnetized to a high temperature and performing magnetization by utilizing a reduction in the magnetized magnetic field required for saturated magnetization is proposed as a technique for improving a deficiency of magnetization (e.g., refer to Patent Document 1). Patent Document 1 discloses a magnetization method in which a permanent magnet, which is an object to be magnetized, is heated to a temperature equal to or higher than a Currie point and a magnetized magnetic field is continuously applied while the temperature of the permanent magnet is decreased from the temperature equal to or higher than the Curie point to a temperature lower than the Curie point.

Further, the temperature of a magnetization unit when the object to be magnetized is taken out from the magnetization unit is controlled to a temperature higher than an upper limit, or a guaranteed temperature, of the use temperature of the device in which the object to be magnetized is incorporated. Accordingly, even when the permanent magnet has a small-diameter multipolar magnetized structure, the average value of the peak values of surface magnetic flux density for all poles is high; a variation in the peak value of surface magnetic flux density is small; the occurrence of an irreversible flux loss is prevented; and the surface magnetic flux density can be finely adjusted to a require value. Thus, a permanent magnet having high magnetization characteristics and excellent magnetization quality can be obtained.

### CITATION LIST

### Patent Literature

Patent Document 1: Japanese Patent No. 4671278

### SUMMARY OF INVENTION

### Problems to be Solved by the Invention

However, the Curie temperature of an SmCo-based rare earth magnet is about 750(° C.) or higher, which is a high temperature, and the upper limit temperature is about 400(° C.) in consideration of the heatproof temperature of the magnetization device, such as the heat resistance of the insulating coating of a magnetization coil. Accordingly, it is virtually impossible to apply the magnetization method disclosed in Patent Document 1 to the SmCo-based rare earth magnet. Thus, it has been difficult to achieve the SmCo-based rare earth magnet having a small diameter and a high coercive force and being subjected to multipolar magnetization at a high magnetization rate.

The present invention has been made in view of the above-mentioned circumstances, and an object of the present invention is to provide an SmCo-based rare earth sintered magnet having a small diameter and a multipolar magnetization magnetic structure and having a high coercive force and a high magnetization rate.

### Solutions to the Problems

The above-mentioned problem is achieved by the present invention described below. That is, an SmCo-based rare earth sintered magnet according to the present invention has an outer shape of any one of a cylindrical shape, a ring-like shape, a columnar shape, and a disk-like shape, an outer periphery or an inner periphery of the SmCo-based rare earth sintered magnet being subjected to multipolar magnetization with the number of poles p (p represents an even number equal to or greater than 4), the SmCo-based rare earth sintered magnet satisfying (a diameter D of a magnetization surface/the number of poles p) (mm)<(4/π) (mm), having a coercive force HCJ (kOe) at a room temperature (° C.) of 7.5 (kOe)<HCJ≦27 (kOe), and having a magnetization rate of 80(%) or more.

Note that the magnetization rate described herein is represented by a ratio obtained from a saturation value for a surface magnetic flux density of a magnetized magnetic pole.

Further, in one embodiment of the SmCo-based rare earth sintered magnet according to the present invention, the diameter D of the magnetization surface is preferably equal to or smaller than 10 (mm).

### Advantageous Effects of the Invention

According to the present invention, even in an SmCo-based rare earth sintered magnet having a small-diameter multipolar magnetic structure that satisfies a magnitude relation of (the diameter D of the magnetization surface/the number of poles p) (mm)<(4/π) (mm), in which it is difficult to generate a large magnetized magnetic field, a coercive force of 7.5 (kOe)<HCJ≦27 (kOe) and a magnetization rate of 80(%) or more can be achieved. Accordingly, the magnetization rate can be drastically improved as compared with a case where the magnetization is performed at a room temperature. This contributes to an increase in the output of a permanent magnet motor and an improvement in the upper-limit temperature of the magnet after the magnetization.

### BRIEF DESCRIPTION OF THE DRAWINGS

FIG. 1 is a perspective view showing an example of an SmCo-based rare earth sintered magnet according to this embodiment.

FIG. 2 is a sectional view showing a magnetic yoke of a peripheral multipolar magnetization device for the SmCo-based rare earth sintered magnet according to this embodiment.

FIG. 3 is a sectional view schematically showing a magnetic yoke having a structure in which an exciting coil is wound around the magnetic yoke shown in FIG. 2.

FIG. 4 is a schematic view showing heating means for the SmCo-based rare earth sintered magnet inserted into the magnetic yoke.

### DESCRIPTION OF EMBODIMENTS

An SmCo-based rare earth sintered magnet according to the present invention, as well as a magnetization method, will be described in detail below. In the magnetization method for the SmCo-based rare earth sintered magnet according to the present invention, the SmCo-based rare earth sintered magnet, which is an object to be magnetized, is heated to an arbitrary temperature that is higher than a room temperature and 400(° C.) or lower, and the coercive force of the object to be magnetized is temporarily reduced. After that, the object to be magnetized is inserted into a magnetic yoke; a magnetized magnetic field is applied in a pulse-like manner; and the SmCo-based rare earth sintered magnet is cooled from the arbitrary temperature to the room temperature. Note that the coercive force of the SmCo-based rare earth sintered magnet that is temporarily decreased due to heating is restored to the value obtained before the heating by cooling the SmCo-based rare earth sintered magnet to the room temperature. Assume that in the present invention, room temperature is 20(° C.).

Assume that the SmCo-based rare earth sintered magnet, which is the object to be magnetized, is an Sm₂Co₁₇ magnet or an SmCo₅ magnet.

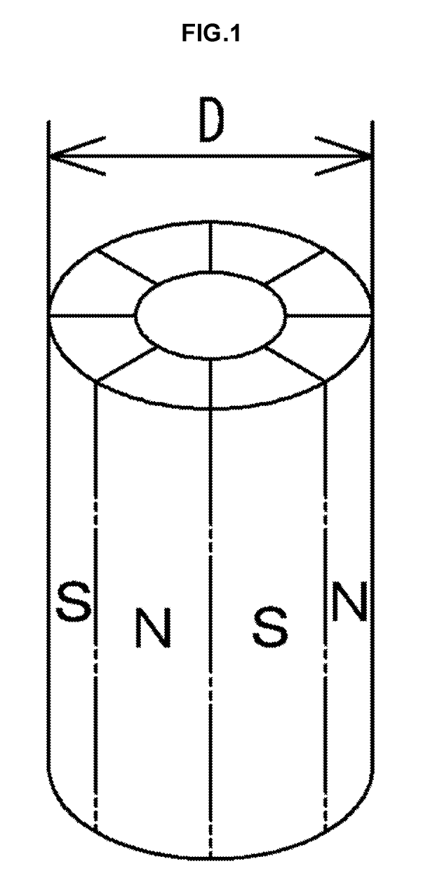

The outer shape of the SmCo-based rare earth sintered magnet, which is the object to be magnetized, is formed into any one of a cylindrical shape (e.g., see FIG. 1), a ring-like shape, or a columnar shape, and a disk-like shape. Although the dimension of a diameter D of a magnetization surface is not particularly limited, it is preferable to set the diameter D of the magnetization surface to 10 (mm) or less, which is suitable for use in a small permanent magnet motor.

As an orientation method of the SmCo-based rare earth sintered magnet, a polar-anisotropy orientation or radial orientation may be employed. Further, a multipolar SmCo-based rare earth sintered magnet having any one of a cylindrical shape, a ring-like shape, a columnar shape, and a disk-like shape may be formed by a combination of a plurality of SmCo-based rare earth sintered magnets having a shape such as an arc shape or a fan shape. When a number of arc-shaped or fan-shaped magnets which are obtained by equally dividing the periphery of an SmCo-based rare earth sintered magnet and correspond to the number of poles are bonded together to form a multipolar SmCo-based rare earth sintered magnet having any one of a cylindrical shape, a ring-like shape, a columnar shape, and a disk-like shape, magnets with a parallel orientation may be used as the arc-shaped or fan-shaped magnets.

In the present invention, since the SmCo-based rare earth sintered magnet is used as the object to be magnetized, the upper limit of the heating temperature is set to 400(° C.) in consideration of ease of cooling the SmCo-based rare earth sintered magnet and the heat resistance of the magnetization device.

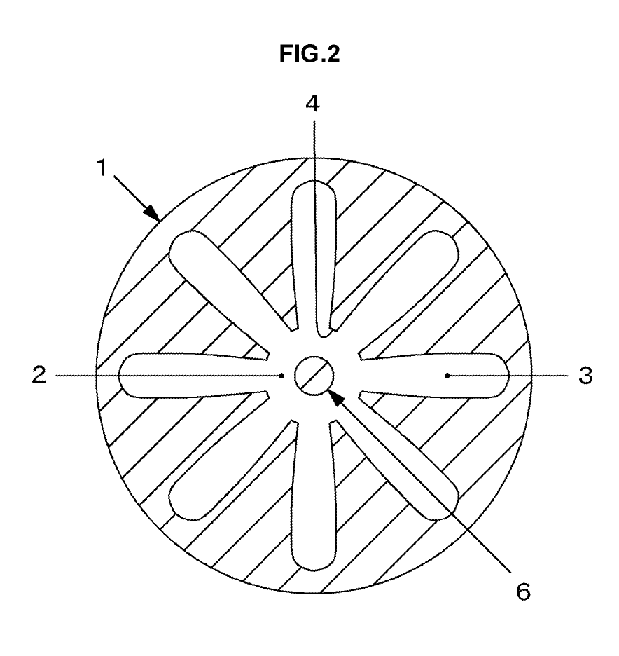

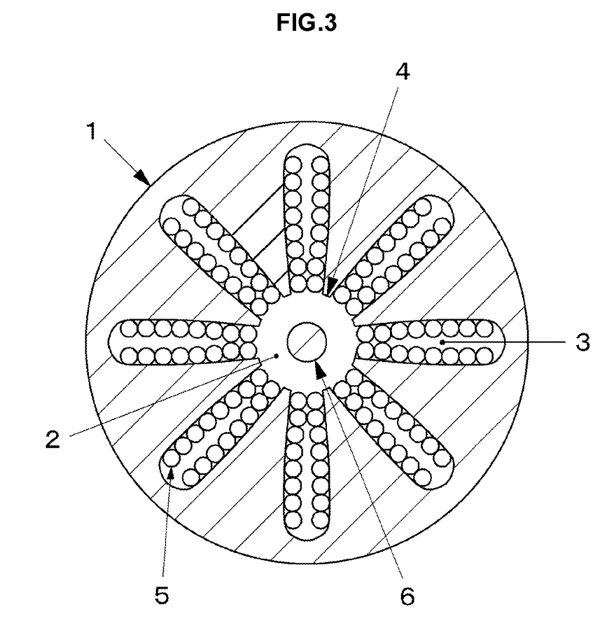

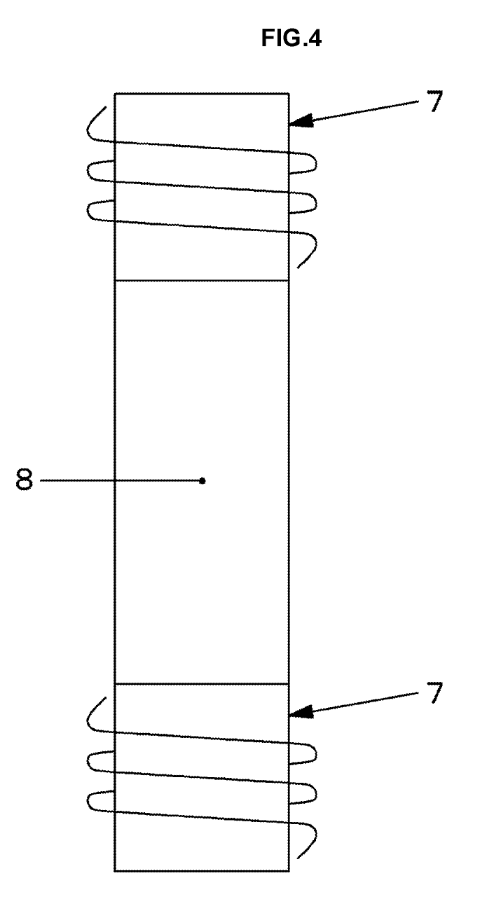

For example, a peripheral multipolar magnetization device for the SmCo-based rare earth sintered magnet according to this embodiment will be described with reference to FIGS. 2 to 4. FIG. 2 is a sectional view showing the magnetic yoke in the peripheral multipolar magnetization device (hereinafter referred to simply as a “magnetization device”, as needed) for the SmCo-based rare earth sintered magnet having a cylindrical shape shown in FIG. 1. FIG. 3 is a sectional view schematically showing that an exciting coil is wound around the magnetic yoke shown in FIG. 2. FIG. 4 is a schematic view showing heating means for the SmCo-based rare earth sintered magnet.

Referring to FIG. 2, the outer shape of a magnetic yoke 1 which constitutes the magnetization device according to this embodiment is formed in a circumferential shape, and the magnetic yoke 1 has a substantially cylindrical shape having a hole 2 formed therein at the center thereof in a substantially circular shape in cross section, and functions as the magnetic yoke for the object to be magnetized. The diameter dimension of the hole 2 is set to an appropriate diameter in consideration of the design of a magnetic circuit during the magnetization of the object to be magnetized.

For example, a permendur material is used as the material for forming the magnetic yoke 1, and a desired number of grooves 3 are radially formed equiangularly from the outer periphery of the hole 2 as shown in FIG. 2 by a boring process of electrical discharge machining. A number of magnetization heads 4 corresponding to a desired number of poles p (p represents an even number equal to or greater than 4) formed in the SmCo-based rare earth sintered magnet serving as the object to be magnetized. The example shown in FIG. 2 assumes eight-pole magnetization. When the magnetic yoke is formed for eight-pole magnetization of the cylindrical SmCo-based rare earth sintered magnet having the diameter (outer diameter) D of the magnetization surface of 5 (mm), the pitch of the magnetization heads 4 is about 2 (mm) and the width of each magnetization head 4 is set to 2 (mm) or less. The value of (the diameter D of the magnetization surface/the number of poles p) (mm) of the magnet of this shape is 0.625 (mm), which is less than (4/π) (mm).

A section of each groove 3 is formed in a curved shape as shown in FIG. 2, and an exciting coil 5 for generating a pulse-like magnetized magnetic field is wound around each magnetization head 4 with a number of turns corresponding to the number of poles p as shown in FIG. 3. A copper wire coil is used as the exciting coil 5. For example, a copper wire having an outer diameter of 1 (mm) is used as the copper wire coil and is wound around each magnetization head 4.

The cylindrical SmCo-based rare earth sintered magnet, which is the object to be magnetized, is inserted into the hole 2 of the magnetic yoke 1 formed as described above. During the insertion of the cylindrical SmCo-based rare earth sintered magnet, the SmCo-based rare earth sintered magnet is held in the central hole of the SmCo-based rare earth sintered magnet through a core bar 6 of the magnetic yoke 1. Next, the SmCo-based rare earth sintered magnet is heated.

The heating means is not particularly limited. For example, any means, such as resistance heating, high-frequency heating, laser heating, high-temperature gas flow heating, or heating in high-temperature liquid can be used. In this embodiment, as shown in FIG. 4, for example, a heating plunger 7 around which a coil for heating is wound is brought into contact with the upper and lower portions of the cylindrical SmCo-based rare earth sintered magnet 8 serving as the object to be magnetized. The SmCo-based rare earth sintered magnet 8 is heated from the upper and lower sides thereof by the heating plunger 7, and the entire SmCo-based rare earth sintered magnet 8 is heated to an arbitrary temperature.

Further, in the present invention, the object to be magnetized is heated to a magnetization temperature T (° C.) which is derived from the following Formula 1, and the SmCo-based rare earth sintered magnet serving as the object to be magnetized is magnetized at the temperature T° C. The number of applications of the pulse-like magnetized magnetic field is set to at least one. It is most preferable to apply the pulse-like magnetized magnetic field once in terms of reduction in time for magnetization and reduction in power consumption.

$$T = RT + \frac{\frac{{H}_{CJ} - \frac{{H}_{ext}}{2}}{{H}_{CJ}} \times 100}{- β} \qquad [ Formula 1 ]$$

where HCJ represents a coercive force (kOe) at a room temperature of the SmCo-based rare earth sintered magnet which is the object to be magnetized; Hext represents a magnetized magnetic field (kOe): β represents the temperature coefficient (%/° C.) of the coercive force of the SmCo-based rare earth sintered magnet serving as the object to be magnetized; and RT represents a room temperature (° C.).

For example, the room temperature RT is set to 20° C., and the heating temperature necessary for the SmCo-based rare earth sintered magnet having the coercive force HCJ at the room temperature of 14 (kOe) and having the temperature coefficient β of the coercive force of −0.19(%/° C.) to be subjected to saturated magnetization by the magnetic yoke having the possible magnetized magnetic field Hext of 15 (kOe) is obtained. When the above-mentioned values are substituted into the above Formula 1, T≈264(° C.) is obtained. After the SmCo-based rare earth sintered magnet is heated to this temperature, the pulse-like magnetic field Hext having the above-mentioned strength is applied, and then the SmCo-based rare earth sintered magnet is cooled to the room temperature, so that the saturated magnetization can be achieved.

The above Formula 1 is a relational expression devised to obtain the temperature (° C.) to which the SmCo-based rare earth sintered magnet serving as the object to be magnetized is heated to achieve the multipolar magnetization.

As described above, in the present invention, the upper limit of the heating temperature of the object to be magnetized is set to 400(° C.), which eliminates the need for heating the SmCo-based rare earth sintered magnet during the magnetization to a temperature equal to or higher than a Curie point. Accordingly, the magnetized SmCo-based rare earth sintered magnet can be cooled in a short period of time.

After it is confirmed that the set temperature is reached by heating, a current is caused to flow through the exciting coil 5 and the pulse-like the magnetized magnetic field Hext is applied to the to-be-magnetized object 8. A value of a maximum pulse current caused to flow through the exciting coil 5 may be calculated by computing an effective reactance of the exciting coil 5.

It has been found out that, in the present invention, when the magnitude of the magnetized magnetic field Hext (kOe) on the object to be magnetized is set to a magnetic field that is at least twice the coercive force HC (kOe) provided at each magnetization temperature T (° C.) by the SmCo-based rare earth sintered magnet serving as the object to be magnetized, the saturation multipolar magnetization can be achieved even when the heating temperature of the SmCo-based rare earth sintered magnet is lower than the Curie point, and the SmCo-based rare earth sintered magnet can be reliably magnetized. Further, when a pulse like magnetic field is used as the magnetized magnetic field Hext, the application of the magnetized magnetic field can be completed in a short period of time. Accordingly, the power consumption during the magnetization can be reduced.

Next, the step of cooling the object to be magnetized will be described. After it is confirmed that the heating temperature of the SmCo-based rare earth sintered magnet has reached an arbitrary temperature T (° C.) and the magnetized magnetic field Hext is applied, the object to be magnetized is cooled. The cooling means is not particularly limited, and any method, for example, natural cooling, as well as forced cooling, such as water-cooling, air-cooling, or gas blasting, or heating temperature adjustment, can be used. In this embodiment, the magnetic yoke 1 is cooled, for example, by a water-cooling method.

As a water-cooling structure for the magnetic yoke 1, for example, a tube line made of copper may be silver-soldered to the outer periphery of the magnetic yoke 1 to circulate water in the tube line, or a vertical through-hole in parallel to the hole 2 may be formed in the periphery of the magnetic yoke 1 to thereby obtain a water-cooling pipe guide.

After it is confirmed that the object to be magnetized is cooled to the room temperature (20(° C.)), the SmCo-based rare earth sintered magnet 8 serving as the object to be magnetized is taken out of the hole 2 of the magnetic yoke 1, and a new object to be magnetized is inserted into the hole 2, thereby repeatedly performing a series of processes of heating, magnetization, and cooling. By the magnetization method as described above, a number of magnetic poles p corresponding to the magnetization heads 4 appear at a high magnetization rate on the outer periphery of the SmCo-based rare earth sintered magnet serving as the object to be magnetized. Assume that the magnetization rate described herein is represented by a ratio obtained from a saturation value for the surface magnetic flux density of the magnetized magnetic poles.

When a test piece was prepared by cutting off a portion of the SmCo-based rare earth sintered magnet 8, which was magnetized and cooled to the room temperature (20(° C.)), in the vicinity of the central portion of the magnetic pole and a magnetization curve was measured by a VSM (Vibrating Sample Magnetometer) to evaluate the magnetization rate, a magnetization rate of 80(%) or more was confirmed. Thus, it can be confirmed that the magnetization method according to this embodiment can increase the magnetization rate of the SmCo-based rare earth sintered magnet to at least 80(%).

Thus, according to the present invention, even in the SmCo-based rare earth sintered magnet having a multipolar magnetic structure, in which it is difficult to generate a large magnetized magnetic field, the magnetization rate can be drastically improved as compared with a case where the magnetization is performed at the room temperature, while preventing the minimum heating temperature based on the above Formula 1 from exceeding 400(° C.). Accordingly, not only the effect of facilitating the cooling process can be obtained, but also a reliable magnetization in a short period of time and a reduction in power consumption can be achieved. Consequently, the heat resistance, mass productivity, and production efficiency of the SmCo-based rare earth sintered magnet can be improved. Further, the improvement in the magnetization rate contributes to an increase in the output of the permanent magnet motor in which the SmCo-based rare earth sintered magnet is mounted.

In an especially highly heat-resistant SmCo-based rare earth magnet having a coercive force of 15 (kOe) or more, imperfect magnetization is likely to occur in conventional methods and it is difficult to maximize the heat resistance of the magnet material. However, according to the magnetization method of this embodiment, the heating temperature is set according to Formula 1, thereby making it possible to achieve the multipolar saturated magnetization and to fully exploit the heat resistance.

By employing the magnetization method according to this embodiment, the magnetization rate can be improved, and at the same time, cooling of the SmCo-based rare earth sintered magnet can be facilitated and the magnetization process can be performed in a short period of time and with low power consumption. Consequently, an improvement in the use upper-limit temperature, mass productivity, and production efficiency of the SmCo-based rare earth sintered magnet can be achieved.

The SmCo-based rare earth sintered magnet 8 of the present invention satisfies the magnitude relation that the value (mm) of (the diameter D of the magnetization surface/the number of poles p) is less than (4/π) (mm) ((the diameter D of the magnetization surface/the number of poles p) (mm)<(4/π) (mm)). In particular, when the diameter D of the magnetization surface is 10 (mm) or less, in the conventional multipolar magnetization method, imperfect magnetization occurs due to a deficiency of the magnetized magnetic field Hext, which results in a decrease in the heat resistance of the rare earth sintered magnet. However, according to the multipolar magnetization method of this embodiment, the saturated magnetization can be achieved and the original heat resistance of the magnet material can be exploited.

When the magnitude relation of (the diameter D of the magnetization surface/the number of poles p) (mm)<(4/π) (mm) is transformed, ((π×D)/p)<4 is obtained. When the diameter D of the magnetization surface is 10 (mm) and the number of poles p is 8, ((π×D)/p) is about 3.9, and thus “4” is set as a threshold.

From Formula 1, 7.5 (kOe) is derived as a minimum coercive force with which a desired magnetization rate (%) can be obtained at the room temperature (20(° C.)) without heating in the magnetized magnetic field Hext of 15 (kOe), which can be generated in the magnetic yoke 1, even when the magnitude relation of (the diameter D of the magnetization surface/the number of poles p) (mm)<(4/π) (mm) is satisfied. Accordingly, a coercive force which is more than 7.5 (kOe) (7.5 (kOe)<HCJ) is set as a lower limit of the coercive force HCJ (kOe) of the SmCo-based rare earth sintered magnet at the room temperature (20(° C.)).

Further, the heat resistance of the magnetic yoke 1 is determined mainly by the heat resistance of the insulating coating of the conductor of the exciting coil 5 and the heat resistance of resin for molding the exiting coil 5, and the practical upper limit of the heat resistance is 400(° C.). Accordingly, when the magnetization is performed at 400(° C.) by the magnetization method according to this embodiment, a coercive force of 27 (kOe) is set to an upper limit as a maximum coercive force with which a desired magnetization rate (%) or more can be achieved. Note that in the present invention, the desired magnetization rate is set to 80(%) or more.

The desired magnetization rate is set to 80(%) or more in the present invention for the following reason. That is, there are Alnico magnets which are said to have a high Curie point and be resistant to a high temperature. Among the Alnico magnets, there is an Alnico 8 having a relatively large coercive force and a high degree of freedom in design with a small size. The applicant of the present application has reached a conclusion that, as a result of review, a magnetization rate of 80% or more is required in view of ensuring the advantage of the magnetic flux density in the SmCo-based rare earth sintered magnet for the Alnico 8.

As described above, even in the SmCo-based rare earth sintered magnet having a small-diameter multipolar magnetic structure that satisfies the magnitude relation of (the diameter D of the magnetization surface/the number of poles p) (mm)<(4/π) (mm), in which it is difficult to generate a large magnetized magnetic field, a coercive force of 7.5 (kOe)<HCJ≦27 (kOe) and a magnetization rate of 80(%) or more can be achieved.

Note that the present invention is not particularly limited to this embodiment. For example, the number of poles of the magnetization heads 4 can be set to any number other than eight. For example, when the diameter D of the magnetization surface of the SmCo-based rare earth sintered magnet serving as the object to be magnetized is 3 (mm) or less, the number of magnetic poles may be changed to four.

Note that the structure of the magnetic yoke 1 and the like may be changed as appropriate depending on the dimensions of the SmCo-based rare earth sintered magnet serving as the object to be magnetized, the number of magnetization heads, and the like.

### Examples

Examples of the present invention will be described below. However, the present invention is not limited only to the following examples.

As an object to be magnetized in Examples, an Sm₂Co₁₇ sintered magnet having a cylindrical outer shape as shown in FIG. 1, the diameter (outer diameter) D of the magnetization surface of 5 (mm), an inner diameter of 3 (mm), and a length of 11 (mm) was used. A magnetic yoke was designed so as to perform peripheral eight-pole magnetization.

The room temperature RT was set to 20 (° C.), and four types of Sm₂Co₁₇ sintered magnets having difference coercive forces at the room temperature were prepared as objects to be magnetized. The objects to be magnetized having coercive forces HCJ of 7.5 (kOe), 8 (kOe), 27 (kOe), and 28 (kOe) were respectively set as test pieces 1 to 4. Note that the temperature coefficient β of each coercive force was −0.19(%/° C.). The heating temperature required for saturated magnetization in the magnetic yoke having the possible magnetized magnetic field Hext of 15 (kOe) was obtained from the above Formula 1, and temperatures T of 20, 53, 400, and 405(° C.) were calculated. However, since it is difficult to heat the objects to be magnetized to 405° C., the objects to be magnetized, which are inserted into the magnetic yoke, are heated to 20, 53, 400, and 400(° C.) for each test piece.

The magnetic yoke constituting the magnetization device used in Examples has a structure shown in FIG. 2 and performs eight-pole magnetization.

After it was confirmed that the temperatures of 20, 53, 400, and 400(° C.) were reached by heating, a current was caused to flow through the exciting coil, and the pulse-like magnetized magnetic field Hext was applied to the objects to be magnetized.

After the magnetization, the Sm₂Co₁₇-based rare earth sintered magnets serving as the objects to be magnetized were cooled by natural cooling while the objects were kept inside the magnetic yoke. After it was confirmed that the objects to be magnetized were cooled to the room temperature (20(° C.)), the surface magnetic flux density in the vicinity of the central portion of the magnetic poles on the outer periphery of each magnet was measured by a gauss meter, and then the magnetization rate was evaluated. In Table 1 showing the evaluation results, test pieces showing a magnetization rate of 80(%) or more are represented by “◯” and test pieces showing a magnetization rate of less than 80(%) are represented by “x.”

TABLE 1

H_{CJ} (kOe)

| | 7.5 | 8 | 27 | 28 |
|---|---|---|---|---|
| Example | ◯ | ◯ | ◯ | X |
| Comparative Example | ◯ | X | X | X |

As shown in Table 1, it has turned out that in the test pieces of Examples, a magnetization rate of 80(%) or more is feasible at HCJ of 27 (kOe) or less, and also it has turned out that the magnetization rate becomes less than 80(%) at HCJ of 28 (kOe). The above results show that in Examples, the magnitude relationship of (the diameter D of the magnetization surface/the number of poles p) (mm)<(4/π) (mm) is satisfied and a coercive force of 7.5 (kOe)<HCJ≦27 (kOe) is obtained, and also a magnetization rate of 80(%) or more can be achieved.

### Comparative Examples

Next, four types of Sm₂Co₁₇-based rare earth sintered magnets having coercive forces HCJ of 7.5 (kOe), 8 (kOe), 27 (kOe), and 28 (kOe) at a room temperature of 20(° C.) were prepared as objects to be magnetized, and the objects to be magnetized were respectively set as test pieces 1 to 4 and were magnetized at the room temperature (20(° C.)). In this manner, Comparative Examples were prepared. The above-described Examples and Comparative Examples differ only in whether or not to heat the objects to the temperature T (° C.) based on Formula 1 during the magnetization and whether or not to perform magnetization at the room temperature of 20(° C.) without heating. The other conditions for Examples are the same as those for Comparative Examples.

Table 1 shows the evaluation results as to the magnetization rate of the test pieces of Comparative examples. Like in Examples, test pieces showing a magnetization rate of 80(%) or more are represented by “◯” and test pieces showing a magnetization rate of less than 80(%) are represented by “x.”

As shown in Table 1, it has turned out that in the test pieces of Comparative Examples, a magnetization rate of 80(%) or more is achieved only when the HCJ is 7.5 (kOe) and a magnetization rate of 80(%) or more cannot be achieved when the HCJ is 8.0 (kOe) or more. Accordingly, it is confirmed that in the small-diameter, multipolar Sm₂Co₁₇-based rare earth sintered magnet that satisfies the magnitude relation of (the diameter D of the magnetization surface/the number of poles p) (mm)<(4/π) (mm), the magnetization rate is insufficient at a high coercive force, and thus it is impossible to achieve a high coercive force and a high magnetization rate at the same time without heating.

### DESCRIPTION OF REFERENCE SIGNS

1 Magnetic yoke
2 Hole
3 Groove
4 Magnetization head
5 Exciting coil
6 Core bar
7 Heating plunger
8 To-be-magnetized object rare-earth magnet)

1. An SmCo-based rare earth sintered magnet having an outer shape of any one of a cylindrical shape, a ring-like shape, a columnar shape, and a disk-like shape, an outer periphery or an inner periphery of the SmCo-based rare earth sintered magnet being subjected to multipolar magnetization with the number of poles p (p represents an even number equal to or greater than 4), the SmCo-based rare earth sintered magnet satisfying a relation of (a diameter D of a magnetization surface/the number of poles p) (mm)<(4/π) (mm), having a coercive force HCJ (kOe) at a room temperature (° C.) of 7.5 (kOe)<HCJ≦27 (kOe), and having a magnetization rate of 80(%) or more.

2. The SmCo-based rare earth sintered magnet according to claim 1, wherein the diameter D of the magnetization surface is equal to or smaller than 10 (mm).
